(19) United States
(12) Patent Application Publication
(10) Pub. No.: US 2023/0064971 A1
(43) Pub. Date: Mar. 2, 2023

(54) PULLEY CONNECTOR BRACKET FOR WINDOW REGULATOR SYSTEMS

(71) Applicant: Magna Closures Inc., Newmarket (CA)

(72) Inventor: Mirko IANNONE, Pisa (IT)

(21) Appl. No.: 17/899,204

(22) Filed: Aug. 30, 2022

Related U.S. Application Data
(60) Provisional application No. 63/239,439, filed on Sep. 1, 2021.

(51) Int. Cl. E05F 15/00

(52) U.S. Cl. CPC E05F 15/00; E05Y 2201/654; E05Y 2201/668; E05Y 2600/46; E05Y 2600/51; E05Y 2600/626; E05Y 2900/55

(57) ABSTRACT

A bracket (102) for mounting a pulley (42a) of a window regulator assembly (30) to a carrier 18a of a closure panel (14) of a vehicle (10), the bracket comprising: a body (106) having a first portion (108) and a second portion (110); a pulley aperture (100a) in the first portion, the pulley aperture having a pulley rotation axis (100b); a connection aperture (104a) in the second portion, the connection aperture having a connection axis, such that the connection axis and the pulley rotation axis are non-concentric; wherein a first fastener (100) is used connect the pulley to the pulley aperture and a second fastener (104) is used to connect the bracket to the carrier.

### CROSS-REFERENCE TO RELATED APPLICATIONS

This application claims priority from the benefit of the filing date of U.S. Provisional Patent Application No. 63/239,439 filed on Sep. 1, 2021, entitled “PULLEY CONNECTOR BRACKET FOR WINDOW REGULATOR SYSTEMS”, the contents of which are herein incorporated by reference.

### FIELD

The present disclosure relates to window regulator systems.

### BACKGROUND

Vehicle doors have windows that can be opened and closed. Within the door, there can be a window regulator assembly including a carrier panel, a motor, rails and window regulator lifter or carrier plate assembly which is driven along is respective rail by the motor with associated cabling. There can be several problems, however, with these window regulator assemblies. For example, in integrated rail door modules it is necessary to connect the pulley for the cable window regulator to the carrier part, which is typically made of plastic material. However, in operation of the pulley, there can be applied undue loads to the carrier, in particular at the attachment point of the pulley through the axis of rotation, which experiences both Z loading and pulley bending moment loads.

### SUMMARY

It is an object of the present invention to provide a pulley attachment interface to obviate or mitigate at least some of the above-presented disadvantages.

A first aspect provided is a bracket for mounting a pulley of a window regulator assembly to carrier of a closure panel of a vehicle, the bracket comprising: a body having a first portion and a second portion; a pulley aperture in the first portion, the pulley aperture having a pulley rotation axis; a connection aperture in the second portion, the connection aperture having a connection axis, such that the connection axis and the pulley rotation axis are non-concentric; wherein a first fastener is used connect the pulley to the pulley aperture and a second fastener is used to connect the bracket to the carrier.

A second aspect provided is a window regulator system for a window of a vehicle, the system including: a carrier for mounting the system to a frame of the vehicle; a pulley for directing a cable of the system; and a bracket for mounting the pulley to the carrier, the bracket comprising: a body having a first portion and a second portion; a pulley aperture in the first portion, the pulley aperture having a pulley rotation axis; a connection aperture in the second portion, the connection aperture having a connection axis, such that the connection axis and the pulley rotation axis are nonconcentric; wherein a first fastener is used connect the pulley to the pulley aperture and a second fastener is used to connect the bracket to the carrier.

A third aspect provided is a method for assembling a window regulator assembly of a vehicle, the method including the steps of: mounting a pulley to a bracket by a first fastener on a pulley rotation axis; and connecting the bracket to the carrier using a second fastener on a connection axis; wherein the connection axis and the pulley rotation axis are non-concentric.

A further aspect provided is a bracket for mounting a pulley of a window regulator assembly to a carrier of a closure panel of a vehicle, the bracket including a body having a first portion and a second portion, wherein the first portion and the second portion extend along separate planes, wherein the second portion is adapted to be secured to the carrier such that the first portion is distanced further away from the carrier than the second portion, wherein the pulley is positioned between the first portion and the carrier when the second portion is secured to the carrier. In accordance with a related aspect, the body includes one or more embossments formed in the body for resisting deformation of the body by the pulley. In accordance with a further related aspect, the body includes a connecting portion extending between the first portion and the second portion.

A further aspect provided is a carrier having a pulley of a window regulator assembly of a closure panel of a vehicle, and a bracket for securing the pulley relative to the carrier, the bracket including a body having a first portion and a second portion, wherein the first portion and the second portion extend along separate planes, wherein the second portion is adapted to be secured to the carrier such that the first portion is distanced further away from the carrier than the second portion, wherein the pulley is positioned between the first portion and the carrier when the second portion is secured to the carrier.

### BRIEF DESCRIPTION OF THE DRAWINGS

The foregoing and other aspects will now be described by way of example only with reference to the attached drawings, in which:

FIG. 1 is a perspective view of a vehicle;

FIG. 2 is a component view of a window regulator system of the vehicle shown in FIG. 1;

FIG. 2A is a perspective view of the window regulator system mounted on a carrier panel of the vehicle shown in FIG. 1;

FIG. 3 is shown is a perspective view of a bracket of the window regulator system of FIG. 2A;

FIG. 4 is a assembled top view of the bracket shown in FIG. 3;

FIG. 5 shown is a cross section A-A of FIG. 4;

FIG. 6 is a bottom view of the bracket shown in FIG. 3;

FIG. 7 is a top view of the bracket shown in FIG. 3;

FIG. 8 is further embodiment of the system shown in FIG. 2A; and

FIG. 9 is an example assembly of the bracket of FIG. 3.

### DETAILED DESCRIPTION

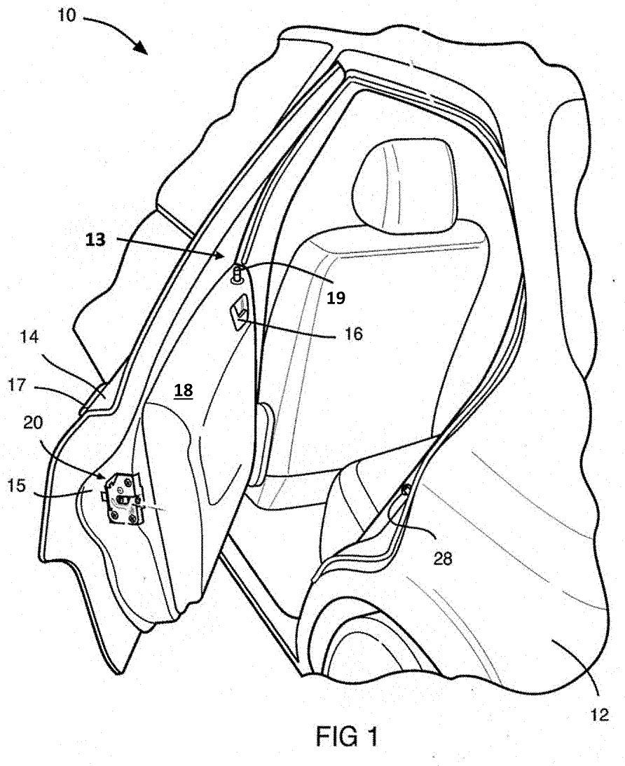

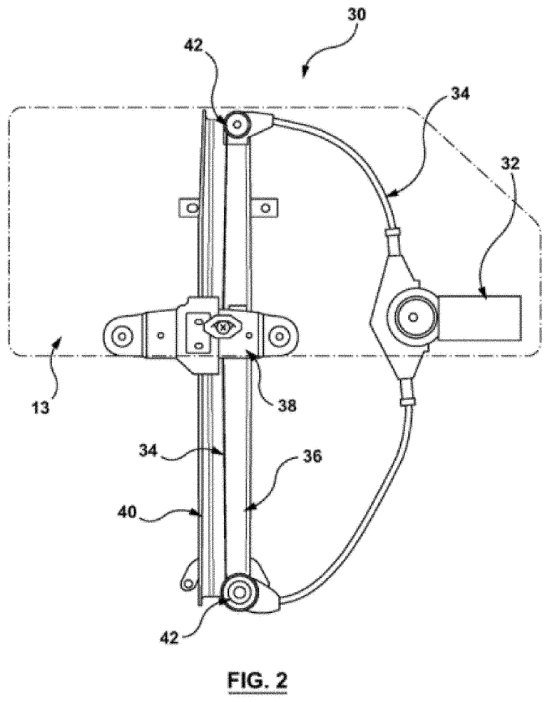

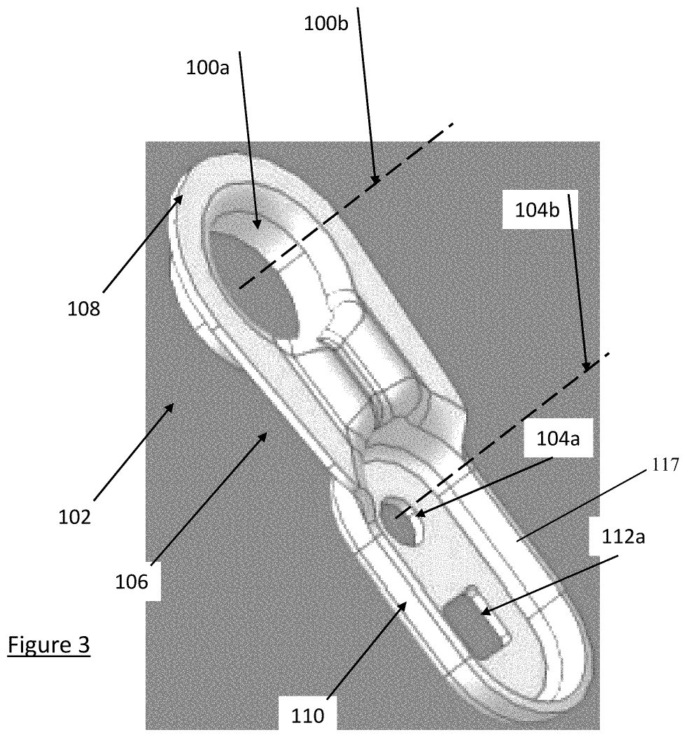

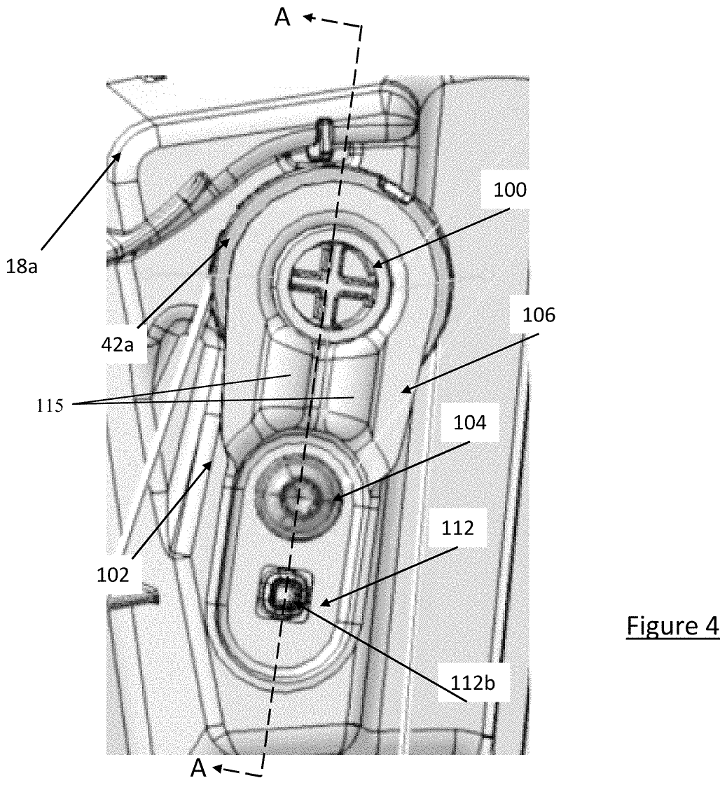

Referring to FIGS. 1, shown is a vehicle 10 that includes a vehicle body 12 and at least one vehicle door 14 (also referred to as a closure panel 14). The vehicle door 14 includes a latch 20 that is positioned on a frame 15 of the vehicle door 14, the latch 20 releasably engageable with a striker 28 on the vehicle body 12 (e.g. including the roof) to releasably hold the vehicle door 14 in a closed position. The frame 15 also supports a window 13 via a window regulator assembly 30 (see FIGS. 2 and 2A—for illustrative purposes only) mounted to the frame 15, as further described below. An outside door handle 17 is provided for opening the latch 20 (i.e. for releasing the latch 20 from the striker 28) to open the vehicle door 14, as well as optionally to operate the window regulator system 30. Further, the vehicle door 14 has an inside control 16 (e.g. door handle, window controls, etc.), with associated optional lock 19, for operating the latch 20 and the window regulator assembly 30, as desired. A door panel 18 is shown providing a cover (e.g. interior panel) over the window regulator assembly 30 (see FIGS. 4 and 5, by example) positioned between the frame 15 and the door panel 18.

For vehicles 10, the closure panel 14 can be referred to as a partition or door, typically hinged, but sometimes attached by other mechanisms such as tracks, in front of an opening which is used for entering and exiting the vehicle 10 interior by people and/or cargo. In terms of vehicles 10, the closure panel 14 may be a driver/passenger door, a lift gate, or it may be some other kind of closure panel 14, such as an upward swinging vehicle door (i.e. what is sometimes referred to as a gull-wing door) or a conventional type of door that is hinged at a front-facing or back-facing edge of the door, and so allows the door to swing (or slide) away from (or towards) the opening in the body 12 of the vehicle 10. Also contemplated are sliding door embodiments of the closure panel 14 and canopy door embodiments of the closure panel 14, such that sliding doors can be a type of door that open by sliding horizontally or vertically, whereby the door is either mounted on, or suspended from a track that provides for a larger opening. Canopy doors are a type of door that sits on top of the vehicle 10 and lifts up in some way, to provide access for vehicle passengers via the opening (e.g. car canopy, aircraft canopy, etc.). Canopy doors can be connected (e.g. hinged at a defined pivot axis and/or connected for travel along a track) to the body 12 of the vehicle at the front, side or back of the door, as the application permits. It is recognized that the body 12 can be represented as a body panel of the vehicle 10, a frame of the vehicle 10, and/or a combination frame and body panel assembly, as desired.

Referring to FIG. 2A, the window regulator assembly 30 is mounted to the door frame 15 (via a carrier 18a mounted to the door frame 15). Rail(s) 36 can be connected directly to the frame 15 (e.g. or as a further embodiment indirectly to the frame 15 via the carrier 18a). Referring to FIGS. 2 and 2A, the window regulator assembly 30 is for moving the vehicle window 13 up and down, i.e. in and out of an enclosure provided between the frame 15 and the door panel 18. The window regulator assembly 30 can include a drive motor and drive mechanism (e.g. gearing) 32 connected to a set of drive cables 34, one or more rails 36 for mounting on the frame 15 (or on an intervening carrier panel 18a as desired), a regulator carriage 38 connected to the window 13 and mounted on the rail 36 for riding along a track 40, and one or more pulleys 42a,b (e.g. upper pulley and lower pulley) for effecting changes in direction of the drive cables 34. In operation of the window regulator assembly 30, the drive motor 32 causes movement of the drive cables 34 which in turn propels the regulator carriage 38 towards one end or the other end of the rail 36, depending upon the rotational direction of the drive motor 32 (e.g. as controlled by the door controls 16,17). It is recognized that the rails 36 can be mounted on the carrier panel 18a by fasteners (not shown—providing an integrated rail module as the window regulator system 30) that is itself mounted to the frame 15 by connectors 15a. Alternatively, the rails 36 of the window regulator system 30 can be mounted directly to the frame 15 without the need for the intervening carrier panel 18a, providing for a piece-wise assembly of the window regulator system 30 directly to the frame 15. It is also recognized that some of the components (e.g. 32, 34, 36, 38, 42a,b) of the window regulator assembly 30 can be mounted to the carrier panel 18a and others of the components (e.g. remaining 32, 34, 36, 38) could be mounted directly to the frame 15 without the intervening carrier panel 18a. In a preferred embodiment, the window regulator assembly 30 is mounted to the carrier panel 18a via fasteners and provided as an integrated door module for fastening as an integrated unit to the frame 15 of the closure panel 14.

Referring again to FIG. 2A, shown is pulley 42a mounted to the carrier panel 18a by a bracket 102, such that the pulley 42a is connected to the bracket 102 via fastener 100 and the bracket 102 is connected to the carrier by fastener 104.

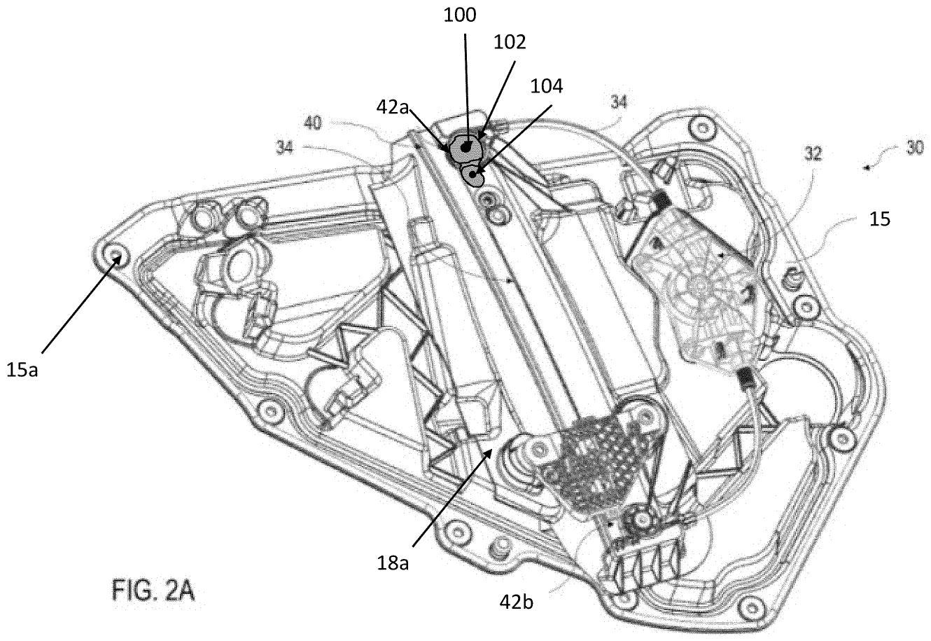

Referring to FIG. 3, shown is a perspective view of the bracket 102. The bracket 102 has a body 106 having a first portion 108 and a second portion 110, such that the first portion 108 has a pulley aperture 100a and the second portion 110 has a carrier aperture 104a. First portion 108 and second portion 110 are provided on separate spaced apart planes P1, P2, for example, as shown in FIG. 5 which are interconnected by a perpendicularly extending flange 111 as a connecting portion and separated by a distance D. Plane P1 of first portion 108 is shown as provided further away from the carrier panel 18a to accommodate the width of the pulley 42a, whereas plane P2 of second portion 110 is provided adjacent to the carrier panel 18a at a distance closer than the plane P1 of the first portion 108. As a result of providing a multi-planer body 106, additional material such as plastic which would be required to be included with carrier panel 18a to support the second portion 110 for a configuration whereby first portion 108 and second portion 110 are on the same plane (e.g. coplanar when body 108 is provided as a flat plate structure) can be dispensed with resulting in reduce material costs and reduction in weight of the carrier panel 18a. For example, additional upstanding structure matching the width of the pulley 42a to support a coplanar second portion 108 may be eliminated due to the multi-planer structure of the body 106. Further, the height of the pin 112b may be reduced by the width of the pulley 42a for example. The fastening point of fastener 104 may be brought close to the carrier 18a plane there by reducing torque moments acting on an extending threaded aperture for receiving the fastener 104a required when the body 106 is plate like singular planar structure. Similarly, torque moments acting on the pin 112a may be reduced to increase the strength of the connections. To resist against the separation of the pulley 42a away from the carrier 18a, the body 106, and for example first portion 108 may include strength features, such as embossment(s) 115. Embossment(s) 115 add strength to the body 106 to resist against the pulley 42a moving in a direction along its axis of rotation possibly to separate from upstanding fastener 100 due to high load states e.g. during a stall condition of the window regulator system. Further strength of the body can be improved by providing upstanding walls 117 shown extending from the second portion 110 for example. The pulley aperture 100a is for receiving the fastener 100 (e.g. pulley fastener) and the carrier aperture 104a is for receiving the fastener 104 (e.g. carrier fastener). It is recognized that the pulley aperture 100a provides a pulley rotation axis 100b, while the carrier aperture 104a provides a connection axis 104b for the fastener 104.

Referring to FIG. 4, shown is the bracket 102 mounting the pulley 42a to the carrier panel 18a by the fasteners 100, 104. The bracket 102 can also utilize a pin and slot connection 112 between the carrier 18a and the bracket body 106, in order to inhibit rotation of the bracket 102 about the fastener 104 during operation of the window regulator assembly 30. Shown by example in FIGS. 3, 4 is a slot 112a in the body 106 and a pin 112b connected to the carrier 18a, however the opposite configuration can also be envisioned, as desired.

Referring to FIG. 5, shown is a cross section A-A of FIG. 4, detailing the pulley 42a mounted on the bracket 102 via fastener 100a and the bracket 102 itself mounted to the carrier 18a by the fastener 104a. Further, shown by example is that the body 106 of the bracket 102 has the first portion 108 offset from the second portion, in order to accommodate the width of the pulley 42a itself. However, it is recognized that the portions 108,110 can be aligned with one another, such that the carrier 18a itself is modified to accommodate for the width of the pulley 42a.

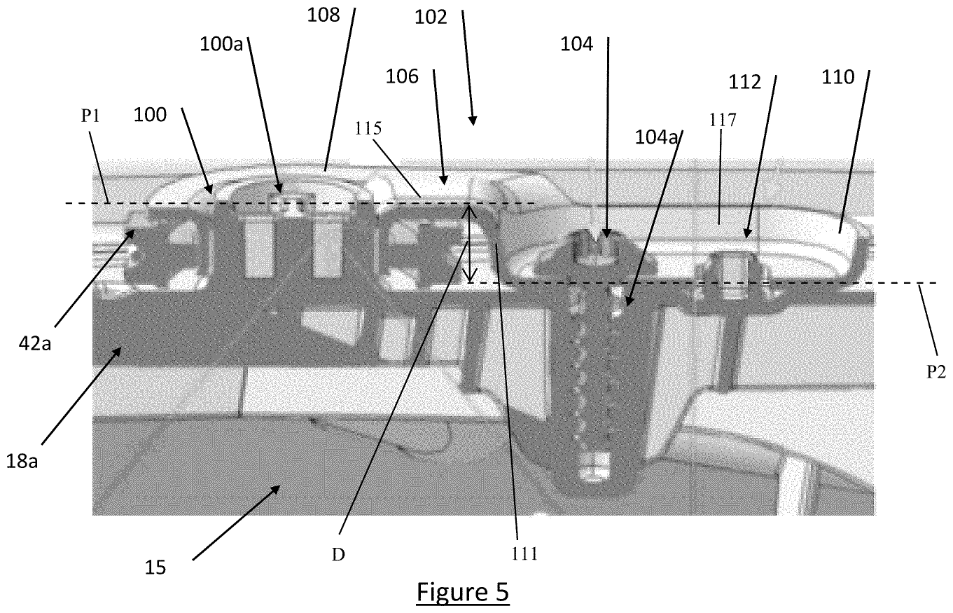

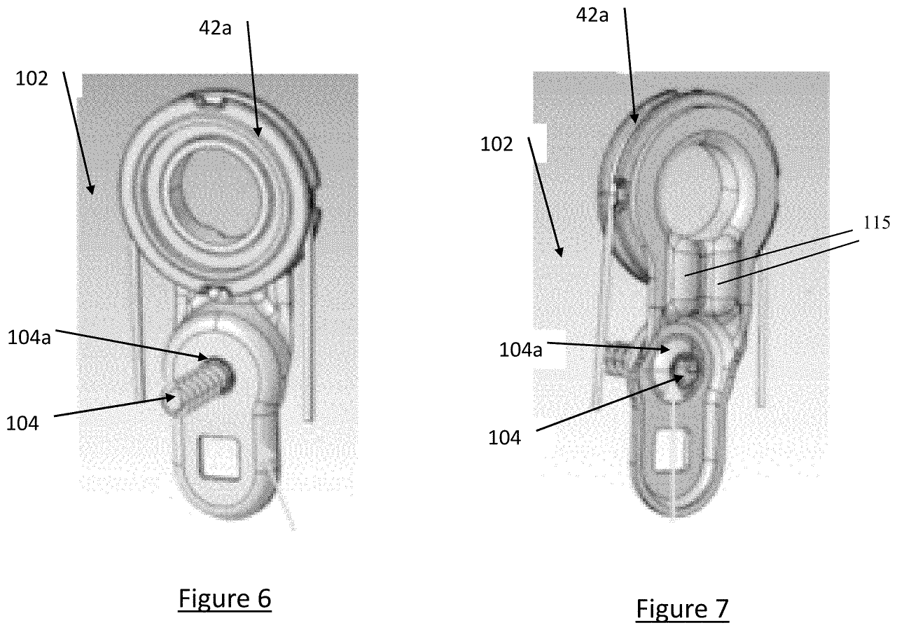

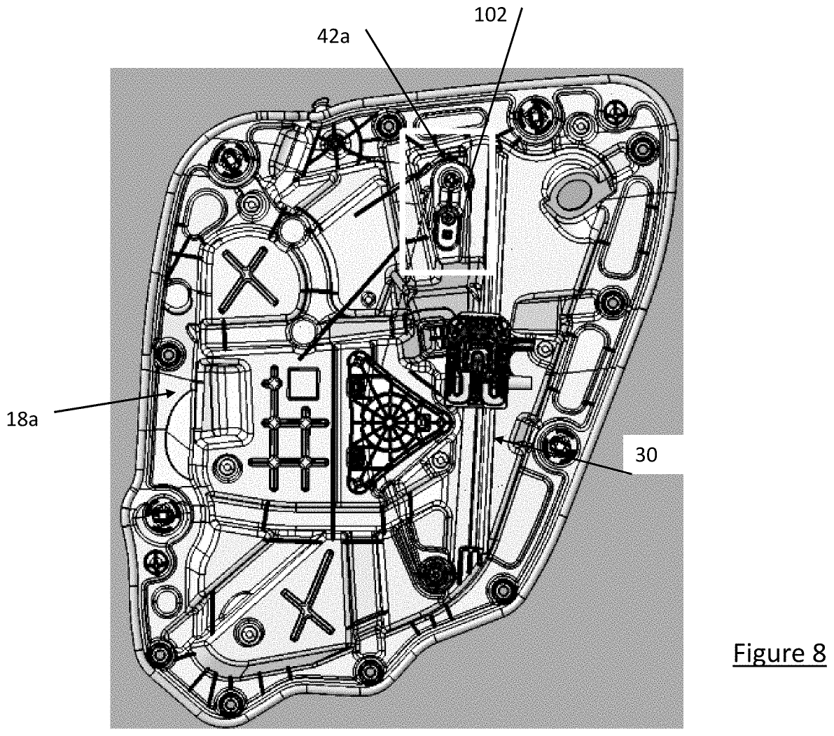

Referring to FIGS. 6 and 7, shown are top and bottom perspective views of the bracket 102 shown in isolation, such that only the pulley 42a is shown without the fastener 100 and the fastener 104 is mounted in the aperture 104a. Referring to FIG. 8, shown is the bracket 102 used to mount the pulley 42a to the carrier 18a, as part of the window regulator system 30.

In view of the above, it is recognized that the top pulley 42a connection (as compared to the lower pulley 42b) can experience the highest loading during a stall condition, in operation of the window regular system. As such, it is advantageous that the pulley 42a is supported for rotation about the connection axis 104b that does not align (i.e. is offset or otherwise unaligned) with the pulley rotation axis 100b provided the fastener 100. In view of this novel configuration of connection with the carrier 18a, using the bracket 102 described above, during operation of window regulator system 30 any pulley 42a loading is not transmitted to the carrier 18a via the fastener 100, but rather via the fastener 104 supporting retention of the pulley bracket 102 in the Z direction (out of plane from the carrier 18a), whereas the pulley 42a is supported about its axis 100b by the fastener 100 through the pulley 42a center for resisting in plane side to side loading (as applied by the drive cables 34 during operation thereof).

This fastener 100 can be made having a larger circumference (as compared to the fastener 104) for engaging with the pulley 42a to increasing load distribution, as compared to a much narrower diameter screw or bolt a prior art pulley could otherwise be supported by when the screw/fastener axis and the pulley axis are concentric. In other words, a diameter of the first fastener 100 can be greater than a diameter of the second fastener 104. Accordingly, the pulley axis 100b and the carrier axis 104b are non-concentric. A further advantage of using the bracket 102 is that the connection point of the bracket 102 to the carrier 18a can be made common/standard via the fastener 104 and optional pin/slot connection 112, since the loading forces on the fastener 104 never change (for differently configured pulleys 42a and the size/power of the window/motor 32 since the loads are no longer support in plane by the pulley fastener 100a in combination with the carrier 18a.

In view of the above, the bracket 102 can be made of a metallic material, for example, and can act as a bracket interface between the pulley 42a and the carrier 18a, such that the bracket is connected to the carrier 18a via fastener 104. As such, the Z load and the pulley bending moment loads are distributed between the two fasteners 100, 104, rather than solely being concentrated at the prior art single fastener—carrier connection for the pulley. The bracket 102 also gives the possibility to use the same carry over fastener and the same torque used for traditional A1 rails, thereby providing for a carrier configuration of traditional front door rails and rear door integrated rails with the same fastener torque design.

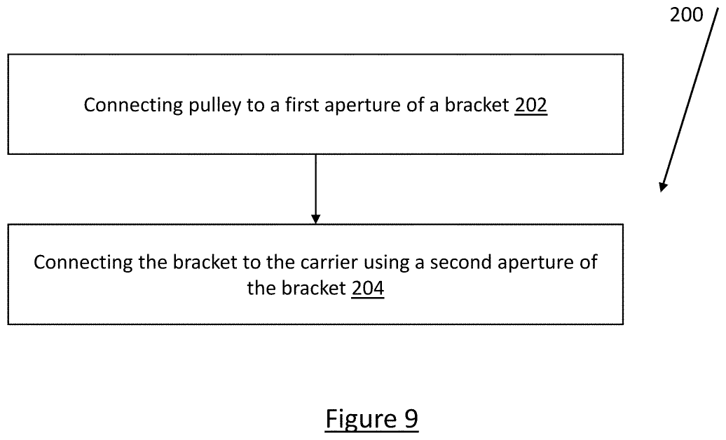

Referring to FIG. 9, shown is a method 200 of assembly of the bracket 102. At step 102, the pulley 42a of the window regulator assembly 30 is mounted to the bracket 102 by the fastener 100 connected to the pulley aperture 100a having the pulley rotation axis 100b. At step 204, the bracket 102 is connected to the carrier 18a using the fastener 104 inserted through aperture 104a having the connection axis 104b. In this manner, the axis 100b, 104b are non-concentric.

While the above description constitutes a plurality of embodiments, it will be appreciated that the present disclosure is susceptible to further modification and change without departing from the fair meaning of the accompanying claims.

We claim:

1. A bracket (102) for mounting a pulley (42a) of a window regulator assembly (30) to a carrier 18a of a closure panel (14) of a vehicle (10), the bracket comprising:
a body (106) having a first portion (108) and a second portion (110);
a pulley aperture (100a) in the first portion, the pulley aperture having a pulley rotation axis (100b);
a connection aperture (104a) in the second portion, the connection aperture having a connection axis, such that the connection axis and the pulley rotation axis are non-concentric;
wherein a first fastener (100) is used connect the pulley to the pulley aperture and a second fastener (104) is used to connect the bracket to the carrier.

2. The bracket of claim 1, wherein a diameter of the first fastener is greater than a diameter of the second fastener.

3. The bracket of claim 1, wherein the first portion is offset from the second portion, in order to accommodate a width of the pulley.

4. The bracket of claim 1 further comprising a pin and slot connection to mount the second portion to the carrier.

5. The bracket of claim 1, wherein the pulley is part of a window regular system (30).

6. A window regulator system for a window of a vehicle, the system including:
a carrier (18a) for mounting the system to a frame (15) of the vehicle;
a pulley for directing a cable (34) of the system; and
a bracket for mounting the pulley to the carrier, the bracket comprising:
a body having a first portion and a second portion;
a pulley aperture in the first portion, the pulley aperture having a pulley rotation axis;
a connection aperture in the second portion, the connection aperture having a connection axis, such that the connection axis and the pulley rotation axis are non-concentric;
wherein a first fastener is used connect the pulley to the pulley aperture and a second fastener is used to connect the bracket to the carrier.

7. The system of claim 1, wherein the first portion is offset from the second portion, in order to accommodate a width of the pulley.

8. The system of claim 1, wherein a diameter of the first fastener is greater than a diameter of the second fastener.

9. A method (200) for assembling a window regulator assembly of a vehicle, the method including the steps of:
mounting (202) a pulley to a bracket by a first fastener on a pulley rotation axis; and
connecting (204) the bracket to the carrier using a second fastener on a connection axis;
wherein the connection axis and the pulley rotation axis are nonconcentric.

10. The method of claim 9 further comprising:
the bracket having a body having a first portion and a second portion;
a pulley aperture in the first portion, the pulley aperture having the pulley rotation axis; and
a connection aperture in the second portion, the connection aperture having the connection axis.

11. A bracket (102) for mounting a pulley (42a) of a window regulator assembly (30) to a carrier 18a of a closure panel (14) of a vehicle (10), the bracket comprising:
a body (106) having a first portion (108) and a second portion (110), wherein the first portion and the second portion extend along separate planes;
wherein the second portion is adapted to be secured to the carrier such that the first portion is distanced further away from the carrier than the second portion;
wherein the pulley is positioned between the first portion and the carrier when the second portion is secured to the carrier.

12. The bracket of claim 11, wherein the body includes one or more embossments formed in the body for resisting deformation of the body by the pulley.

13. The bracket of claim 11, wherein the body includes a connecting portion extending between the first portion and the second portion.
